(19) United States
(12) Patent Application Publication
(10) Pub. No.: US 2008/0061127 A1
(43) Pub. Date: Mar. 13, 2008

(54) Banknote System

(75) Inventor: Dirk Brexel, Geseke (DE)

Correspondence Address: HARNESS, DICKEY & PIERCE, P.L.C., P.O. BOX 828, BLOOMFIELD HILLS, MI, 48303, US

(73) Assignee: Wincor Nixdorf International GmbH, Paderborn (DE)

(21) Appl. No.: 11/792,352

(22) PCT Filed: Dec. 2, 2005
(86) PCT No.: PCT/DE05/02176

§ 371 Date: Jun. 5, 2007

(30) Foreign Application Priority Data
Dec. 17, 2004 (DE) 10 2004 061 467.9

(51) Int. Cl. G07F 19/00; G06F 7/08

(52) U.S. Cl. 235/379; 235/381

(57) ABSTRACT

The invention relates to a banknote system for inputting and outputting banknotes and a method for controlling the banknote system. Specified is a banknote system for inputting and outputting banknotes and a method for controlling a banknote system, by means of which a multiplicity of nominal values can be processed and which is characterized by a space-saving construction. In particular, a space-saving storage of banknotes having different nominal values is provided in a simple manner by storing banknotes having at least two different nominal values in one storage unit. The value of a banknote is determined with the aid of a detection unit for determining the nominal value, such that the nominal value of the stored banknote is known. The determined nominal value of a banknote is preferably saved in a control unit, such that the sequence of the stored banknotes in terms of their nominal value is known for each storage unit. Consequently, it is not necessary to provide a separate cartridge for each nominal amount in the banknote system according to the invention.

The invention relates to a banknote system for inputting and outputting banknotes. Banknote systems are known in which banknotes that are to be distributed are taken from cartridges, in which the banknotes are stored, and are supplied to these cartridges in the case of deposits. Such banknote systems, in which banknotes are taken from a cartridge and banknotes of equal value are supplied to this cartridge again, are also called recycling systems because the supplied banknotes can subsequently be taken from the cartridge again. In comparison with known drum-store arrangements, this cartridge-based recycling system allows simple operation when filling and emptying the banknote system.

A further development of the invention relates to an extended stock management of the banknotes which are located in a network of banknote systems.

In the case of a cartridge-based banknote recycling system, it is necessary to provide a separate cartridge for each different note value that is to be processed by the banknote system, or to limit the quantity of note values that are processed in the banknote system to the quantity of cartridges provided. The note value of a banknote is the nominal amount in the currency of the banknote. Cartridges of a suitable size, in which a sufficiently large quantity of banknotes can be stored, require a relatively large amount of space however, such that no more than five cartridges can be arranged in normal banknote systems. Since the size of a banknote system in the case of an automatic teller machine, for example, is however an important criterion when selecting these devices, there is a requirement for solutions whereby a small size can be achieved while maintaining or even extending the known functionality. Furthermore, in the case of current systems, analysis of the fill level of the cartridges is only partially possible since it is not possible to exclude double withdrawals, note jams, etc.

The invention addresses the problem of specifying a banknote system for inputting and outputting banknotes and a method for controlling a banknote system, by means of which a multiplicity of nominal values can be processed and which is characterized by a compact and inexpensive construction. Furthermore, the banknote system will be characterized by an improved stock management and an optimization of the distribution profiles. In particular, it will be possible to dispense with an intermediate storage for cancelled deposit amounts, in order to allow an even more compact structural design of the banknote system.

This problem is solved by a banknote system for inputting and outputting banknotes and having the features in patent claim 1. Advantageous developments of the invention are specified in the dependent patent claims.

A space-saving storage of banknotes having different nominal values can be provided easily by storing banknotes having at least two different nominal values in one storage unit. This mixed storage is made possible by a detection unit for determining the nominal value of a banknote when the banknote is input or output. The determined nominal value of a banknote is preferably saved in a data processing entity, such that the sequence of the stored banknotes in terms of their nominal value is known for each storage unit. Consequently, it is not necessary to provide a separate cartridge for each nominal amount in the banknote system according to the invention. Since the nominal value of the banknote is determined again when it is output, it is possible to ensure that the desired total amount is distributed and that no distribution errors occur.

An important aspect of the invention relates to the control of the cartridges by the control unit. Since the banknotes are examined by the detection unit in respect of their nominal value, and the control unit then stores the banknotes in one of the cartridges depending on the determined nominal value and possibly on the fill level of the relevant cartridges, the sequence of the banknotes in the individual cartridges is saved in a memory of the control unit. If a specific total amount is to be output, an optimization algorithm in the control unit is used to establish which banknote is withdrawn from which cartridge in order to be able to offer the desired total amount. If the total amount can only be realized by withdrawing banknotes which are arranged behind banknotes that are not required, these banknotes that are not required are likewise withdrawn and stored in an intermediate storage unit from where they can then be transported back into the cartridge.

In a development of the invention, banknotes having different nominal values are supplied selectively to at least two storage units for secure storage. Banknotes of a first nominal value are preferably supplied to the first storage unit and banknotes of at least a second and a third nominal value are supplied to the second storage unit for storage. With the aid of the detection unit, the nominal value of a banknote is determined and then forwarded to the data processing entity. Thus, if a banknote which is supplied to the banknote system has a first nominal value, it is supplied e.g. to the first storage unit. Notes having a second or third nominal value are supplied to the second storage unit. The nominal value of the banknote which is taken from a storage unit for output from the banknote system is likewise detected with the aid of the detection unit in order to avoid distribution errors.

When a plurality of cartridges is utilized in a banknote system, one of the cartridges is preferably filled in a denomination-oriented manner using banknotes of the smallest nominal value, i.e. this cartridge contains only banknotes having the same nominal amount. As a result, any amount which is divisible by this smallest nominal amount can be output exactly. Hence any amount, e.g. exactly 5 euros or exactly $1 US, can be output if the cartridge holding banknotes of the lowest nominal value contains banknotes of 5 euros or $1 US respectively. As a result of this, the method according to the invention ensures a precise output of a total amount.

The processing and recycling of banknotes having at least theoretically any number of different nominal amounts is nonetheless possible, since the data concerning the fill level of a storage unit, e.g. the sequence of the stored banknotes according to their nominal values, is saved in the data processing entity such that an optimized stock management becomes possible on the basis of a corresponding algorithm. If a specific amount is to be output, the appropriate banknotes can be withdrawn in each case from the relevant cartridges with reference to the known fill levels of the storage units.

A further aspect of the invention relates to an extended stock management of a banknote system network consisting of a plurality of banknote systems. The storage units are equipped with an identification code such as a memory chip and/or an RFID chip for identification and/or a further control and memory unit. The fill-level data of a storage unit is saved either on the memory chip or on a server, such that, if the storage units are switched, the exchanged storage unit can be reintegrated into the stock management of a banknote system.

For better understanding of the present invention, reference is made below to the preferred exemplary embodiments illustrated in the drawings, said exemplary embodiments being described on the basis of specific terminology. It should be noted, however, that the scope of protection of the invention should not be restricted thereby, since such changes and further modifications to the illustrated devices and to the method and such further uses of the invention such as are shown therein are considered to be conventional specialized knowledge, either now or in the future, for a person skilled in the relevant art. In the drawing:

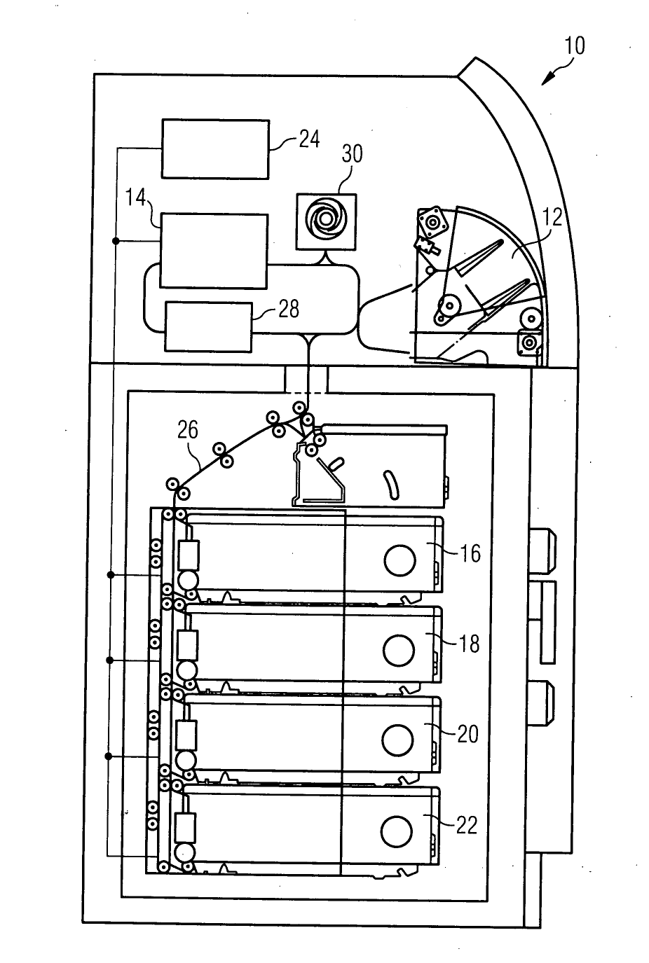

FIG. 1 shows a block schematic diagram of a banknote system.

A banknote system 10 of an automatic teller machine is illustrated in FIG. 1. However, the banknote system can also take the form of an automatic teller safe in the field of banking or also an automatic cash drawer for commercial enterprises, for example. In principle, the invention described here can be utilized for any system by means of which banknotes are input and/or output. The banknotes which are to be supplied to the banknote system 10 and output from the banknote system 10 are respectively supplied or taken via an input/output tray 12. However, it is also conceivable for the input tray and the output tray to be physically separate from each other. A banknote which is supplied via the input/output tray 12 is first supplied to a banknote reading device 14 which determines inter alia the nominal value of the supplied banknote. This nominal value is also referred to as the denomination. The banknote reading device 14 advantageously detects not only the nominal value of a supplied banknote, but also the authenticity of the supplied banknote, and is also called a banknote sensor. Next, the banknote is supplied to one of the storage units 16 to 22. The storage units 16 to 22 preferably take the form of cartridges.

The banknote system 10 which is illustrated here has four cartridge-type storage units 16 to 22 in which banknotes can be securely stored. The individual banknotes are preferably arranged vertically in the storage units 16 to 22 as a banknote batch. The banknote batch is preferably arranged edgeways in the cartridge. Alternatively, the banknote batches can also be arranged horizontally in the storage units 16 to 22. The taking of the banknotes which have been supplied to a storage units 16 to 22 is preferably done in accordance with the last-in/first-out principle, whereby the banknote which was last to be supplied to a storage unit 16 to 22 is first to be withdrawn again from this storage unit 16 to 22.

The banknote reading device 14 is connected to a data processing entity 24, in which is saved the value of each banknote that has been read and stored. As a result of saving the sequence of the banknotes which have been input into a cartridge, it is possible to manage each individual banknote which has been input. Since the sequence of the input banknotes is saved in a memory of the data processing entity 24, intelligent stock management of the banknotes stored in the cartridges is possible using corresponding algorithms. If the banknotes are withdrawn from the storage units 16 to 22 again, they pass through the banknote reading device 14 again. The guaranteeing of a precise note output is an essential difficulty in the case of cartridge-based recycling systems, since double withdrawals or note jams cannot be excluded. Checking the withdrawn banknotes again is therefore necessary in order to ensure an exact distribution of the requested banknotes.

The banknote reading device 14 in conjunction with the data processing entity 24, which can be connected to a server or host computer, therefore provides the basis for an intelligent stock management, since each banknote passes through the banknote reading device 14 and the significance and if applicable the authenticity of the banknote is detected and saved in the data processing entity 24. The serial number of the banknote can also be detected, such that each banknote can be identified not just on the basis of its significance, but also as an individual banknote. Furthermore, an algorithm in the data processing entity establishes which cartridge the banknote should be stored in or withdrawn from.

Because the banknote passes through the reading device 14 when it is stored in the cartridges and when it is distributed, an exact stock management of the money in the banknote system 10 is possible. This allows both the realization of mixed storages in the cartridges, i.e. the utilization of a cartridge for a plurality of denominations, and a stock optimization since, by virtue of the known saved storage profiles in the cartridges, output of a banknote wad can be optimized with reference to the banknote stock using corresponding algorithms.

In particular, it is possible to detect multiple withdrawals or incorrect withdrawals as a result of the banknotes passing through the banknote reading device 14 during the distribution, such that incorrect distributions can be avoided. These incorrect withdrawals are advantageously stored in an intermediate storage or transported back into the cartridges. Instead of an intermediate storage, it is also possible to use a storage tray in which the banknotes are stored. However, this means that they are removed from the money cycle in the device.

As a result of mixed storage of different denominations in a cartridge, the quantity of the required cartridges in an automatic teller machine can be decreased, such that the overall size can be reduced.

Moreover, an intermediate storage unit which is provided in existing deposit systems for cancellations of the deposited amount can be omitted, since in the case of a cancellation of a deposit transaction the deposited money can be withdrawn from the cartridges and made available to the customer again. Since the deposited money is checked by a genuine-money sensor first, if forged money is deposited, it is retained by means of storage in a dedicated storage unit. In the case of a cancellation, this money is not returned. However, the banknotes which prove to be genuine can be returned from the cartridges again.

Furthermore, a cartridge for wads which halve been incorrectly compiled, e.g. due to double withdrawals, or for money wads which are inadvertently not taken by the customer and are retracted again by the automatic teller machine after a specified time interval can be omitted, since these, wads can be decollated and then supplied back to the cartridges again. Since the individual note passes through the banknote reading device 14 again before storage in a cartridge, the individual banknotes can be included in the stock management of the cartridges again.

Since the sequence of the stored banknotes in the individual cartridges is saved in an electronic memory of the data processing entity 24, the data processing entity 24 can determine an optimized control of the cartridges. In the case of a requested amount of 700 euros, for example, a sequence of banknotes which gives this total amount might already be present in a cartridge. It is thereby possible to reduce the effort of the control unit 24 when providing the desired total amount and the amount can be provided more quickly. Alternatively, it is possible to control a plurality of cartridges, the compilation of a banknote wad being based on the saved banknote profiles in the cartridges, whereby, a stock optimization of the cartridges is possible by means of an intelligent control using corresponding algorithms. Overall, therefore, provision is made for an intelligent stock management of the stored banknotes in the individual cartridges, as a result of which it is possible to manage each individual banknote that has been input and output. Since the note sequence in the cartridges is known, an algorithm can determine beforehand the notes which are to be distributed to the customer. The second passage through the banknote system 10 is used as a reference/actual comparison and prevents the distribution of incorrect distributions. In total, only those notes are withdrawn which are required for the compilation of a wad of banknotes. In particular, the composition of a banknote wad comprising different denominations can be varied depending on the installation location of the device, the time of day or the customer profile, for example.

In addition, the banknote system 10 advantageously contains an intermediate storage unit 30. If a specific distribution amount can only be provided by withdrawing a further banknote and the previously withdrawn banknote is not required, this banknote is transported to the intermediate storage unit 30. The intermediate storage unit 30 can be a drum store. From the intermediate storage unit 30, the banknote can be stored in a cartridge again.

The banknote system is advantageously not operated with completely mixed cartridges, but there are cartridges which are only filled with one nominal value and there are cartridges which include mixtures of two or three denominations. For example, banknotes having the nominal value of 5 euros can be stored in the first storage unit 16, banknotes having the nominal values of 10 euros and 20 euros can be stored in the second storage unit 18, banknotes having the nominal value of 50 euros can be stored in the third storage unit 20, and mixed banknotes having the nominal values of 100 euros, 200 euros and 500 euros can be stored in the fourth storage unit 22. The nominal value of the banknote, this being detected by the detection unit 14, is forwarded to a control unit 24 which controls the transport entities (not illustrated) of the banknote system 10 such that these banknotes are supplied to the storage unit 16 to 22 which is provided for this nominal value. The currency and the cited denominations are merely exemplary. The cash system 10 can obviously also be operated with other currencies and other denominations. It is also possible for a plurality of currencies to be processed concurrently by the banknote system 10, provision being preferably made for at least two storage units for each currency.

Overall, the cartridges are configured such that they are suitable for various denominations and currency sets.

In a development of the invention, the cartridges can be equipped with a memory medium such as a memory chip in which the stored note profile can be saved, such that a switch of a cartridge from one banknote system to another is possible, particularly if one banknote system is primarily utilized as a deposit device and another as a distribution device. This presupposes that the cartridges are compatible for installation in various banknote systems. When the filled cartridge is inserted into the banknote system which is primarily used as a distribution device, the data can be read out from the memory chip and the cartridge can be integrated into the stock management of the banknote system concerned.

However, it is also possible for the cartridges to be equipped with identification markers such as RFID tags, for example. If the cartridges are switched from one system to another, the specific cartridge is then identifiable. The sequence of the stored banknotes in the cartridge is advantageously saved on a central server in the case of this variant, such that stock management of the banknotes in the cartridge is again possible via the server.

Overall, using a standard cartridge, it is possible to achieve a technology platform for the handling of the money stocks in a network comprising different banknote systems. This significantly reduces the logistical effort for cartridges to be utilized, since the cartridges of a banknote distribution system can be used again for a banknote deposit system within the banknote systems of preferably a bank. The utilization of an external money administration center such as a central bank can therefore be avoided, since a closed money cycle e.g. within a financial institute becomes possible. As a result of this, the costs for the money handling can be significantly reduced, since the counting, sorting and management of the deposited money is dealt with by the banknote systems themselves. By using optimization algorithms for the filled cartridges, it is possible to determine the distribution unit and deposit unit whose cartridges should preferably be reciprocally exchanged.

When withdrawing banknotes from the cartridges for the purpose of compiling a wad of banknotes, problems always occur if complete stock management is not possible due to notes sticking in the banknote system. This can arise as a result of note jams or double withdrawals. The reading device 14 is the essential checking medium, therefore, in order that a reference/actual comparison can be carried out. In addition to the reading device 14, however, use is made of a further sensor technology such as e.g. devices for thickness measurement and/or light barriers, in the banknote system. Provision is further made for a decollation device by means of which double withdrawals of banknotes can be decollated again. These problems can additionally be solved by the analysis of the subsequently withdrawn notes, since the sequence of the stored notes in the cartridges is saved.

In a development of the invention, provision can be made or equipping the cartridges themselves with further sensor technology elements in order to establish how many notes have been taken or supplied.

In order to output a desired total amount, the control unit 24 controls the transport entities of the banknote system 10 such that a banknote is taken from a storage unit 16 to 22 and supplied on the transport path 26, this being illustrated by a solid line, to the banknote detection unit 14 for determining the nominal value of the banknote. The determined nominal value is transferred to the control, unit 24. After checking again that the nominal value of the banknote taken from the storage unit corresponds to the saved nominal value, the banknote is transported onwards from the banknote detection unit 14 to the input/output tray 12. In addition, the banknote system 10 advantageously includes an alignment station 28 in order to allow an accurate transport and a tidy storage of the banknotes in the cartridges.

Further exemplary loadings of cartridges in a banknote system 10 are shown below. Thus provision can be made for a denomination-oriented basic loading, wherein e.g. the cartridge 16 is filled with banknotes having the nominal value of 10 euros, the cartridge 18 is filled with banknotes having the nominal value of 20 euros, the cartridge 20 is filled with banknotes having the nominal value of 50 euros, and an empty deposit cartridge is provided. Deposited banknotes having the nominal value of 5 euros are supplied to the cartridge containing the banknotes of 10 euros. A distribution of 10 euros takes place either by means of two banknotes having the nominal value of 5 euros or by distributing one banknote having the nominal value of 10 euros. Since either two banknotes of 5 euros or one banknote having the value of 10 euros is available in the cartridge, no more than one banknote need be stored in an intermediate storage.

However, provision can also be made for a single-denomination cartridge containing banknotes having the nominal value of 5 euros, wherein the deposited notes of 10 euros are stored in the cartridge containing the notes of 20 euros. Or a cartilage with mixed storage of notes having the nominal values of 5 euros, 10 euros and 20 euros can be provided.

In addition to a denomination-oriented basic loading, it is also possible to realize a mixed basic loading in conjunction with a mixed storage. In this case, all cartridges 16 to 20 are loaded with all denominations and an intermediate storage cartridge 22 is provided for the storage of banknotes which are not suitable for the planned wad compilation but which must nonetheless be withdrawn since only the subsequent banknote is suitable.

### LIST OF REFERENCE NUMERALS

10 Banknote system
12 Input/output tray
14 Detection unit
16 22 Storage unit
24 Data processing unit
26 Transport path
28 Alignment station
30 Intermediate storage unit

1. A banknote system for inputting and outputting banknotes having different nominal values, comprising:
at least one storage unit, to which banknotes can be supplied in each case for secure storage, and from which the banknotes can be taken again,
detection unit for determining the nominal value of a banknote,
a data processing entity for saving the nominal values of the banknotes which are stored in the storage unit and for controlling the input and output of the banknotes,
an intermediate storage unit for the storage of banknotes,
wherein banknotes of different nominal values can be stored in the storage unit,
wherein the detection unit detects the nominal value of the banknotes which are supplied to the storage unit and the nominal value of the banknotes which are taken from the storage unit, and transfers said detected nominal values to the data processing entity, and
wherein the nominal value of the stored banknotes and the sequence of the storage in the storage unit are saved in the data processing entity.

2. The system as claimed in claim 1, wherein a stock management of the fill level of the storage unit can be carried out on the basis of the nominal values which are saved in the data processing entity and relate to the banknotes that are stored in the storage unit.

3. The system as claimed in claim 1, wherein provision is made for at least two storage units.

4. The system as claimed in claim 1, wherein provision is made for at least a third and a fourth storage unit.

5. The system as claimed in claim 1, wherein the storage units are constructed as separate modules in the form of cartridges.

6. The system as claimed in claim 1, wherein the banknotes are arranged as a batch in the storage units.

7. The system as claimed in claim 1, wherein the storage units are equipped with a memory and control entity.

8. The system as claimed in claim 1, wherein the storage units are equipped with an RFID chip.

9. The system as claimed in claim 1, wherein the intermediate storage unit is designed as a drum store.

10. The system as claimed in claim 1, wherein the intermediate storage unit is designed as a cartridge.

11. The use of the banknote system as claimed in claim 1, wherein for an automatic teller safe system.

12. A method comprising:
controlling a banknote system for input and output,
in which the nominal value of a banknote is determined with the aid of a detection unit when the banknote is input into the banknote system and when the banknote is output from one of the storage units, and
in which the nominal value of the stored banknote is forwarded to a data processing entity and saved, and
in which banknotes are selectively supplied to one of the storage units, wherein the storage is controlled by the data processing entity depending on the detected nominal value of the banknote, and
in which, for the output of a banknote wad having a specific total amount, the taking of the banknotes from the storage units is controlled by the data processing entity by means of a stock management algorithm which is based on the knowledge of the sequence of the stored banknotes in the storage units.

13. The method as claimed in claim 12, wherein the storage units are equipped with a memory medium in which is saved the data relating to the fill level of the storage units such as the sequence of the stored banknotes.

14. The method as claimed in claim 12, wherein the data relating to the fill level of a storage unit is saved on a server.

15. The method as claimed in claim 12, wherein in the event of a switch of a storage unity from a first bank system to a second bank system, the data relating to the fill level of the storage unit can be read from the memory medium or can be retrieved from a server on the basis of an identification code of the storage unit, and consequently it is possible to perform a stock management of a banknote system network comprising a plurality of banknote systems.

16. A method for controlling the output of banknotes from a banknote system as claimed in claim 1, the data processing entity determines an optimized composition of a banknote wad that is to be output, said wad comprising banknotes from the storage units, on the basis of the sequence of the banknotes which are stored in the storage units, said sequence being saved in a memory, and correspondingly controls the storage units such that the desired total amount is provided by withdrawing banknotes of suitable nominal value from the storage units.

17. The method as claimed in claim 16, wherein the nominal value of the withdrawn banknotes is determined by the detection unit in order to prevent incorrect distributions.

18. The system as claimed in claim 2, wherein provision is made for at least two storage units.

19. The method as claimed in claim 13, wherein the data relating to the fill level of a storage unit is saved on a server.
